(19) United States
(12) Patent Application Publication
(10) Pub. No.: US 2010/0058276 A1
(43) Pub. Date: Mar. 4, 2010

(54) Method for the integration of an integrated circuit into a standardized software architecture for embedded systems

(76) Inventors: Andreas Felder, Odenthal (DE); Peter Stadler, Wenden (DE); Jens Beerhold, Koeln (DE)

Correspondence Address: Delphi Technologies, Inc., M/C 480-410-202, PO BOX 5052, Troy, MI, 48007, US

(21) Appl. No.: 12/283,425

(22) Filed: Sep. 11, 2008

(30) Foreign Application Priority Data
Sep. 11, 2007 (EP) 070177790.2

(51) Int. Cl. G06F 17/50

(52) U.S. Cl. 716/17

(57) ABSTRACT

A method is disclosed for the integration of an integrated circuit into a standardized software architecture for embedded systems. The method includes a definition of a computer readable standardized data structure which is completed with the properties of the integrated circuit. The completed standardized data structure is then used for the definition of a hardware module which includes the integrated circuit. The hardware module definition thus generated is exported in a form which can be imported by the standardized software architecture for embedded systems for further processing.

### TECHNICAL FIELD

The present invention relates to general software architectures and in particular to a method for the integration of an integrated circuit into a standardized software architecture for embedded systems.

### BACKGROUND OF THE INVENTION

The miniaturization of electronic components which has been progressing without halt for decades with a simultaneous growth in the complexity thereof that has been accompanied by a corresponding growth in the extent and in the complexity of software systems which have been developed for the control of assemblies which include electronic components and to satisfy specific objects. In this context, assemblies which include electronic components are generally called “hardware modules”, software systems for the control of the hardware are generally called “operating systems” and software systems to satisfy specific objects are generally called “applications”.

In the computer systems well known from the office world, in particular personal computers, an open hardware architecture prevails which enables a replacement of hardware modules with non-identical hardware modules and/or an addition of additional hardware modules. A temporary connection of the personal computer to additional hardware modules and devices is also possible via standard interfaces (e.g. USB). For this purpose, the operating systems developed for personal computers include processes which enable a recognition of changed hardware as well as a largely automatic integration of software modules (drivers) which are required for the correct control of newly added or replaced hardware modules.

In contrast to this, embedded systems are as a rule closed systems with fixedly defined hardware modules which cannot be replaced by non-identical hardware modules without problems. Embedded systems are designed for fixedly outlined objects and application areas, for example monitoring and control objects in an industrial environment or for use in motor vehicles. Due to a frequently harsh site of use and other industrial demands on robustness and reliability as well as due to cost considerations, embedded systems as a rule have much lower hardware resources (processor computing power, available RAM, available ROM, interfaces, etc.) than personal computers, for example. The required reliability and robustness as a rule make the use of specific hardware technologies from the personal computer environment (hard disks, fans, etc.) more difficult and require special hardware adaptations (e.g. hardware watchdog to detect a “system crash” and to restart the system automatically).

There are accordingly special demands on the software architecture for embedded systems. The demands on such software architectures in particular include specific real time abilities (to guarantee a reaction to an incident within a defined time period), an effective “slim” core (i.e. the operating system of an embedded system should require as few resources as possible) and a high robustness, reliability and security to enable use in safety-critical areas.

The development and maintenance of such software architectures for embedded systems is extremely time intensive and cost intensive. For this reason, there are commercially available operating systems and operating systems based on open source for embedded systems. Together with these operating systems, tool chains matched thereto are available for the adaptation of the operating systems to a desired hardware platform or to a desired hardware module as well as for the development of applications in a higher programming language (frequently C or C++) so that complete software development systems are available for embedded systems.

To integrate a hardware module which is tailored to special demands and as a rule includes a plurality of integrated circuits (e.g. ASICs, FPGAs, CPLDs, etc.) and/or “building blocks” (cf. the following definition) into a corresponding software architecture for embedded systems or to get an operating system for embedded systems to run thereon, at least the following two steps are required:

1. Preparation and/or adaptation of software modules (drivers) for the control of the integrated circuits and/or building blocks used on the hardware module on the basis of the documentation of the integrated circuits or of the building blocks while taking account of the software architecture of the operating systems used for embedded systems.

2. Configuration of the operating system for embedded systems to integrate the prepared and/or adapted software modules, with the connections of the individual integrated circuits or building blocks predetermined by the circuit diagram of the hardware module having to be taken into account.

The documentation of the used integrated circuits or building blocks must be used in both the preparation/adaptation of software modules and in the configuration of the operating system for embedded systems; i.e. the respective developer and/or project engineer must study and implement the documentation.

The procedure described above of the integration of a hardware module into a software architecture for embedded systems proves to be costly, complex and prone to error in practice.

### SUMMARY OF THE INVENTION

It is therefore the object of the invention to facilitate the procedure for the integration of a hardware module into a software architecture for embedded systems.

This object is satisfied by the subject matters of the independent claims.

For reasons of simplicity, the method in accordance with the invention will be described in the following under the perspective of the integration of an integrated circuit. The method in accordance with the invention can, however, equally also be used for the integration of so-called building blocks into a standardized software architecture for embedded systems. “Building blocks” are understood in this context, for example, as standardized sensors and actuators as well as delineated, discretely set up circuit sections which have a fixedly defined function.

The method in accordance with the invention for the integration of an integrated circuit into a standardized software architecture for embedded systems includes a definition of a computer readable standardized data structure in which all information can be stored which is required for the description of the properties of the integrated circuit. This standardized data structure is completed with the properties of the integrated circuit so that all the information known for a specific integrated circuit (electrical specification, programming interface, errors) is contained. The completed standardized data structure is used to define a hardware module which includes the specific integrated circuit. Finally, the hardware module definition is exported in a form which can be imported by a standardized software architecture for embedded systems for further processing.

The use provided in the method in accordance with the invention of the computer readable standardized data structure, which includes all the known information on the integrated circuit, has the following advantages:

Developers of software modules for the integration of the integrated circuit and project engineers who carry out the definition of the hardware module can begin their work without any time-consuming study of the documentation of the integrated circuit as soon as a completed standardized data structure is present.

Suitable software tools can in each case provide the developer of software modules and/or the project engineer with precisely the information from the completed standardized data structure which is required to satisfy the respective object, which can result in a substantial acceleration of work and in a reduction in the error rate.

New findings on an already used integrated circuit (e.g. an error recognized later) can be recorded and taken into account fast.

A new generation of the integrated circuit (e.g. due to a shrink process, a new mask or new firmware) or a new integrated circuit which is intended to replace an existing integrated circuit can easily be integrated.

In a preferred embodiment of the method, an extensible description language is used for the description of hierarchically structured data for the definition of the standardized data structure. Description languages, in particular the family of markup languages, are very well suited for the description of the properties of physical objects. They also facilitate the use of different abstraction levels. A field of memory cells can thus be defined, for example, by means of a suitable structure and the total field, a cell of the field or a bit from a cell of the field can be addressed. Extensible description languages, in particular extensible markup languages, also have the feature of the extensibility of the “extent of the language”. The most varied properties of an integrated circuit can thus be mapped completely.

A preferred embodiment provides that the standardized data structure is completed by the manufacturer or distributor of the integrated circuit. This presents itself since the manufacturer or distributor has all the information on the integrated circuit and makes this available in a documentation so that the effort for the completion of the standardized data structure remains clear. The manufacturer or distributor will also increase the market acceptance of the integrated circuit by the provision of a completed standardized data structure. Alternatively, the standardized data structure can also be completed by a software developer and/or a project engineer.

In preferred embodiments of the method for the integration of an integrated circuit into a standardized software architecture for embedded systems, the definition of the hardware module includes first defining demands on the hardware module. Said demands include mechanical demands (e.g. module dimensions, arrangement of connectors, bore holes etc.), electrical demands (operating voltage, operating current, power consumption, etc.), environmental demands (working temperature range, storage temperature range, humidity resistance, vibration resistance, etc.), functional demands (what functions the hardware module has to satisfy), etc. Subsequently, the completed standardized data structure (and optionally further completed standardized data structures) is added and the hardware module is configured. The configuration of the hardware module in turn includes the steps that relationships between the integrated circuits, which are included by the hardware module, are configured, the input/output interfaces and communication interfaces of the hardware module are configured and software modules for the integration of the hardware module into the standardized software architecture for embedded systems are prepared.

As part of the definition of the hardware module, the completed standardized data structures are thus interlinked (or the circuit diagram of the hardware module is defined) and software modules are prepared for the integration into the software architecture of the embedded system.

A computer readable memory medium in accordance with the invention includes a computer program which is stored thereon and which represents a set of instructions. When the latter are executed on a computer, they cause a computer to read in demands on a hardware module and to read in completed standardized data structures which describe the properties of integrated circuits which are covered by the hardware module. In addition, when they are executed by the computer, they cause the computer to read in relationships between the integrated circuits covered by the hardware module, to read in a configuration of input/output interfaces and communication interfaces of the hardware module, to support a preparation of software modules which are required for the integration of the hardware module into a standardized software architecture for embedded systems and to export the read in data and prepared software modules in a format readable by a standardized software architecture for embedded systems.

The computer readable memory medium in accordance with the invention with the computer program saved thereon supports the integration of a hardware module into a standardized software architecture for embedded systems in that it facilitates substantial steps in the preparation of software modules and in the definition of a hardware module. The integration of integrated circuits into the hardware module definition is substantially facilitated and accelerated by the possibility of reading in completed standardized data structures since a definition of the read in integrated circuits in the hardware module definition already takes place by the reading in. The preparation and/or adaptation of software modules is supported and facilitated in a similar manner since all the information required for this purpose is provided by the reading in of the completed standardized data structures and the reading in of the demands on the hardware module and no longer have to be looked up in a complex manner.

Particularly preferred embodiments of the computer readable memory medium in accordance with the invention with the computer program stored thereon are directed to a use in the automotive industry. In these embodiments, the hardware module as a rule includes an electronic control unit (ECU) and the standardized software architecture for embedded systems into which the hardware module should be integrated includes the open system architecture for the automotive industry (AUTOSAR Automotive Open System Architecture).

### BRIEF DESCRIPTION OF THE DRAWINGS

The invention will be described in the following purely by way of example with reference to an advantageous embodiment and to the enclosed drawing. In this:

FIG. 1 is a schematic representation of an embodiment of the method in accordance with the invention for the integration of an integrated circuit into a standardized software architecture for embedded systems;

FIG. 2 is a schematic setup of a hardware module which shows exemplary integrated circuits;

FIG. 3 is an abstract schematic setup of the software architecture of the AUTOSAR system which shows the points in the AUTOSAR system at which the method in accordance with the invention engages; and

FIGS. 4A-4F are an example of the standardized data structure in accordance with the invention.

### DESCRIPTION OF THE PREFERRED EMBODIMENT

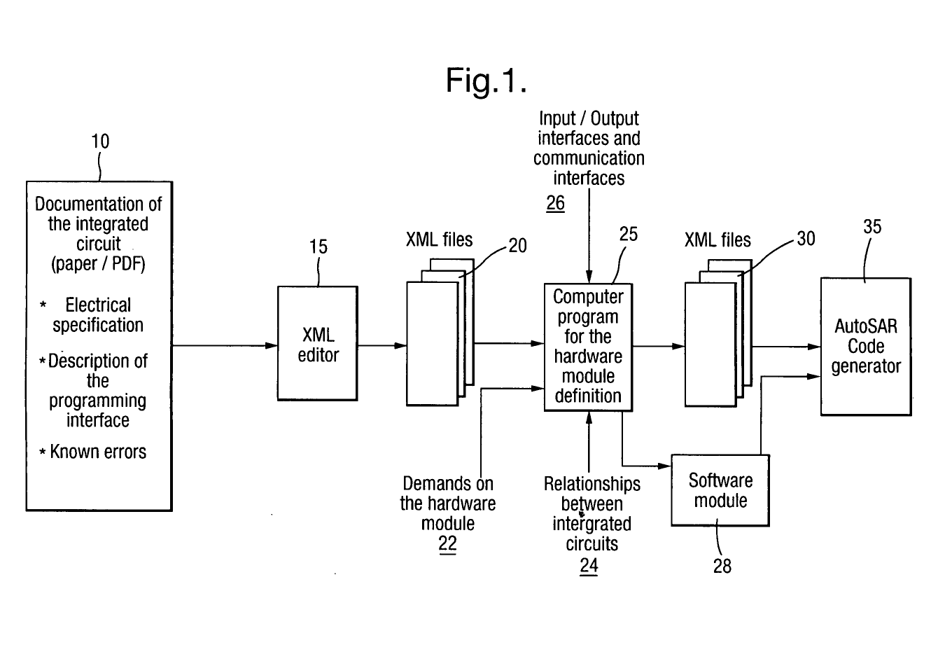

FIG. 1 represents the method in accordance with the invention for the integration of an integrated circuit into a standardized software architecture for embedded systems for the example of the AUTOSAR system. In this connection, one or more XML files 20 are generated with the help of an XML editor 15 from a documentation 10 of an integrated circuit which generally includes an electrical specification, a description of the programming interface of the integrated circuit and a list of known errors. The XML files 20 in this connection comprise the standardized data structure in accordance with the invention and contain all the information contained in the documentation 10 of the integrated circuit. Any desired XML editor 15 known in the art can be used for the generation of the XML files 20. The preparation of the XML files 20 can take place by the manufacturer or distributor of the integrated circuit or by a software developer or project engineer. An automatic generation of the XML files 20 from the documentation 10 of the integrated circuit is also possible with the help of suitable software.

A suitable computer program 25 for the hardware module definition reads in the XML files 20 and the demands 22 on the hardware module to be defined. Said demands include mechanical demands (e.g. module dimensions, arrangement of connectors, bore holes, thickness and finish of circuit boards etc.), electrical demands (operating voltage, operating current, power consumption, etc.), environmental demands (working temperature range, storage temperature range, humidity resistance, vibration resistance, etc.), functional demands (what functions the hardware module has to satisfy), etc. These demands 22 can either be read in from files or input interactively. Based on the XML files 20 and on the demands 22, the computer program 25 reads relationships 24 between the integrated circuits, which are already read in with the help of the XML files 20, and other components covered by the hardware module to be defined and configures required input/output interfaces and communication interfaces 26. This input and configuration process takes place interactively.

A user of the computer program 25 can now prepare or configure possibly required software modules 28 with the support of the computer program 25 to enable a correct control of all the components which are included in the hardware module definition.

Finally, the prepared hardware module configuration is exported in a format which can be processed by the tools of the desired standardized software architecture for embedded systems, AUTOSAR in this embodiment. XML files 30 are generated for AUTOSAR in this example.

The steps described in the preceding for the definition of a hardware module can also be carried out in a different order and also iteratively until the result corresponds to the demands.

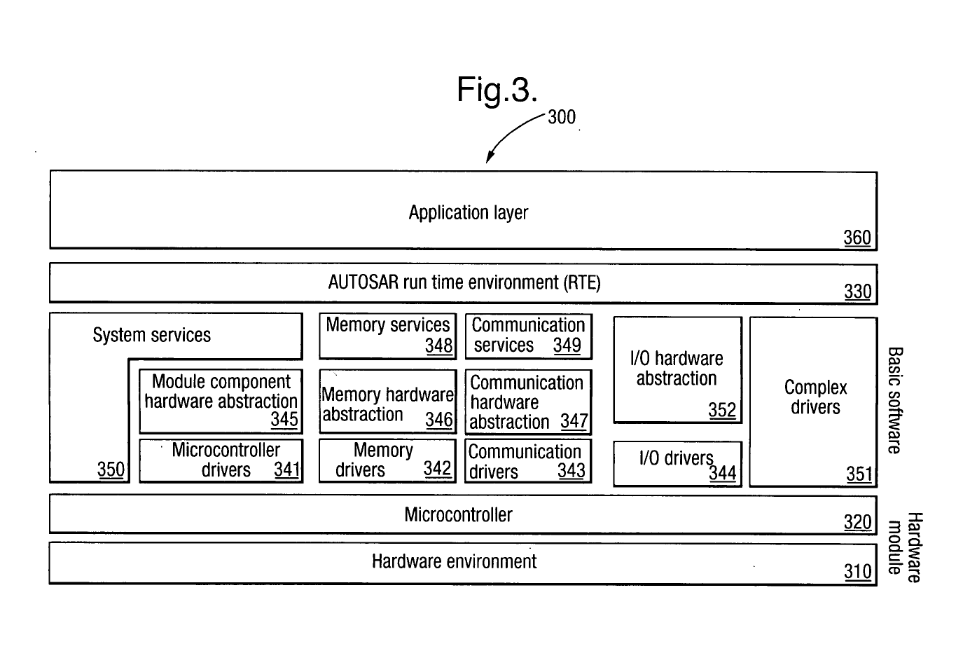

The prepared software modules 28 and the XML files 30 are subsequently further processed by the respective tools of the used standardized software architecture for embedded systems. With AUTOSAR, this is typically a code generator 35 and a compiler and link procedure whose result is an AUTOSAR run time environment (cf. FIG. 3) which is adapted to the defined hardware module.

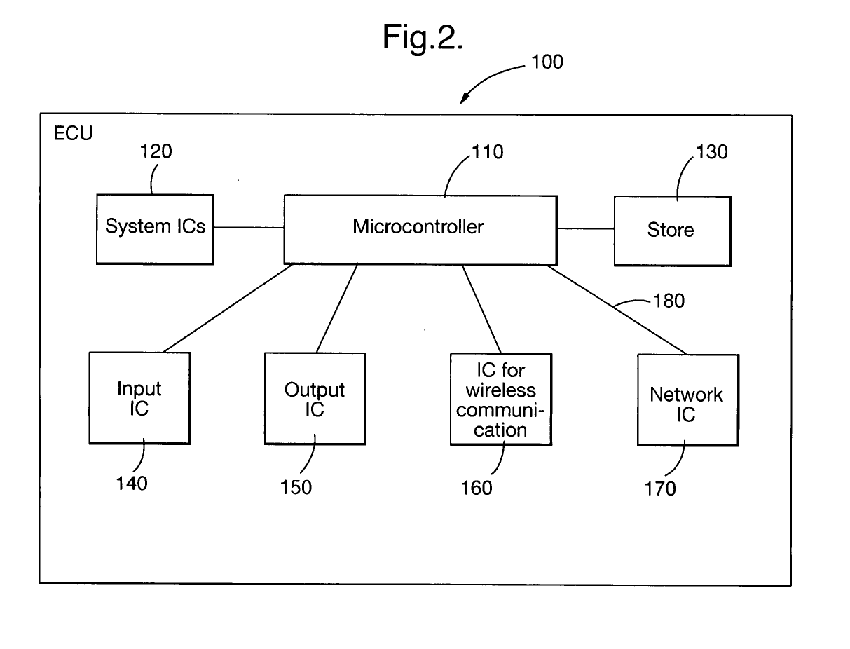

FIG. 2 shows a schematic setup of a hardware module, in this example of a typical electronic control unit (ECU) 100 such as is used in modern motor vehicles. The ECU 100 includes a microcontroller 110 which is connected to a set of system ICs 120 which it needs for correct functioning. In addition, the microcontroller 110 can access a memory 130 which is as a rule designed as a ROM (e.g. an EEPROM) and includes commands and/or data which the microcontroller 110 accesses in operation. A RAM (random access memory) is as a rule already completely included in the microcontroller 110 for space and cost reasons.

The ECU 100 as a rule has a series of integrated components (ASICs, FPGAs, CPLDs, etc.), for the carrying out of the specific control objects for which the ECU 100 was developed, which were developed and/or are adapted for specific functions, for example input ICs 140, output ICs 150, communication ICs for wireless communication 160 as well as for wired communication 170, etc. The microcontroller 110 is electrically connected to the integrated components 140, 150, 160 and 170 listed in the preceding to control them and to exchange data. The electrical connection is designed in this connection using known techniques and communication protocols; for example, the SPI bus (serial peripheral interface bus) 180 is used for this purpose.

The method in accordance with the invention is used for the integration of the integrated circuits (ICs) 140, 150, 160 and 170 shown in FIG. 2 into a standardized software architecture for embedded systems to facilitate and accelerate this procedure.

An abstract schematic setup 300 of the software architecture of the AUTOSAR system is shown in FIG. 3. The hardware module whose definition is facilitated by the method in accordance with the invention consists of the blocks hardware environment 310 and microcontroller 320. The hardware environment 310 block includes inter alia the integrated circuits 140, 150, 160 and 170 of FIG. 2 whose integration is facilitated by use of the standardized data structure. A base software which includes a plurality of components is provided for the adaptation of the AUTOSAR run time environment (RTE) 330 to the hardware environment 310 and the microcontroller 320. These components are arranged in three layers. The driver layer comprises the components 341, 342, 343 and 344, the abstraction layer comprise the components 345, 346 and 347 and the middleware includes the components 348 and 349. In addition, there are the components 350 (system services) and 351 (complex drivers) which include all three layers. Finally, the component 352 (I/O hardware abstraction) must be named which is located in the abstraction layer and in the middleware. The method in accordance with the invention is directed to simplifying the preparation of the I/O hardware abstraction. The AUTOSAR run time environment 330 makes use of the components of the base software listed in the preceding to provide the required functions for the applications which run in the application layer 360. For this purpose, it calls up the standardized functions which have to be provided by the respectively addressed components. In the preparation of the software modules for the control of the integrated circuits, care must be taken to implement this interface correctly. The AUTOSAR run time environment 330 provides a hardware-independent platform; this means that an application of the application layer 360 can also run on another hardware module which has the AUTOSAR run time environment.

The computer readable standardized data structure in accordance with the invention will be explained more precisely in the following with reference to a preferred embodiment. XML (eXtensible Markup Language) is used for the definition of this data structure. XML uses “tags” or marks to describe objects. These tags can be stacked inside one another, whereby hierarchical structures can be mapped. The structuring tags are preset in the described standardized data structure.

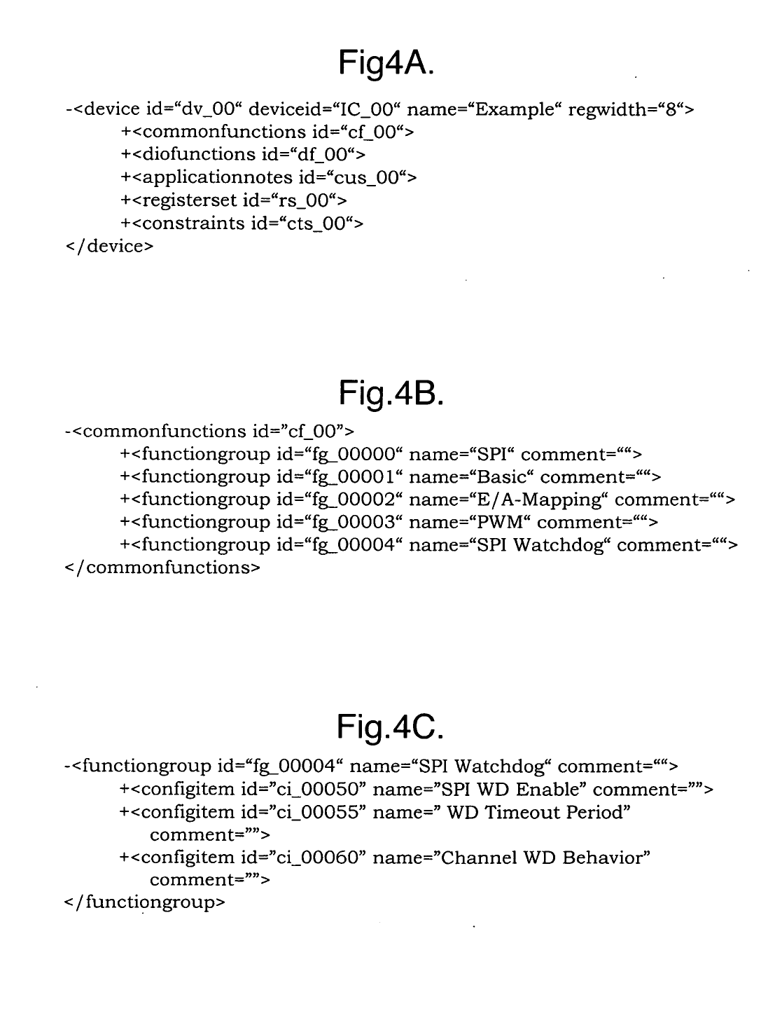

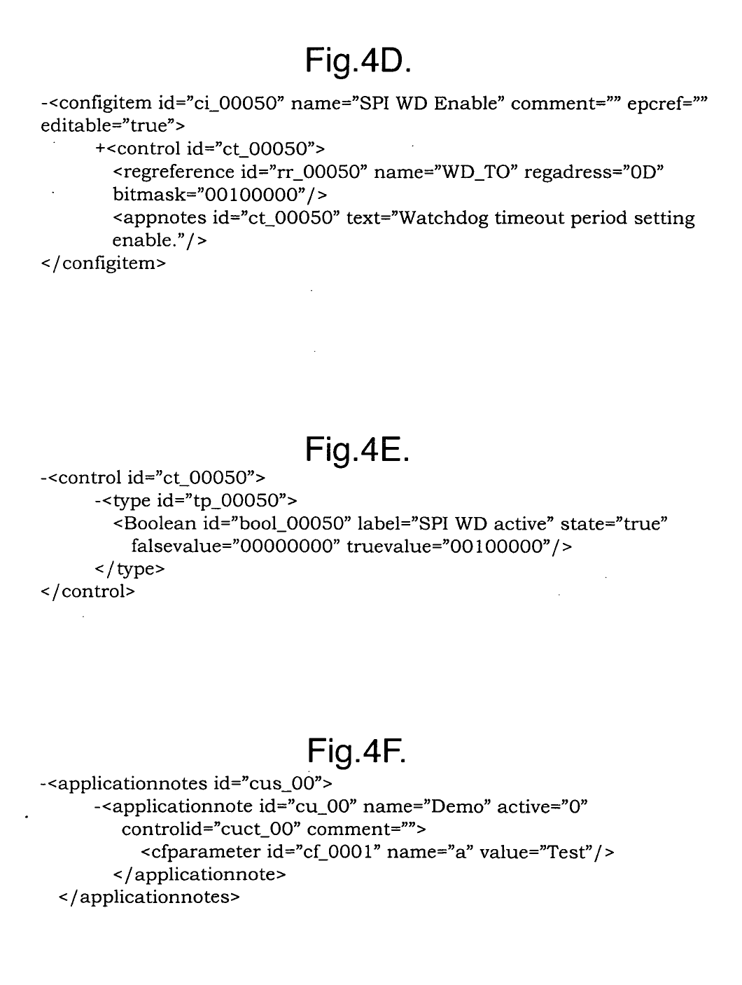

FIG. 4A shows the topmost hierarchy level of the standardized data structure in accordance with the invention. The integrated circuit with the name “Example” is described in the chapters “commonfunctions” (general functions of the IC, e.g. a watchdog), “diofunctions” (specific input/output functions of the ICs), “applicationnotes” (definition of functional calls), “registerset” (description of the registers of the ICs) and “constraints” (restrictions or limits of the ICs). A plus sign (“+”) in front of a line indicates that the line “includes” further lines and thus forms the title for the “included” lines.

The chapter “commonfunctions” is opened in FIG. 4B. The integrated circuit “Example” of FIG. 4A accordingly has a total of five function groups in the chapter “commonfunctions” which are characterized by lines starting with the tag <functiongroup>. The number of the functional groups depends on the integrated circuit to be described and can be both larger than and smaller than five. The name of the functional group can be fixed by the user and should meaningfully describe the function.

At FIG. 4C, the function group with the name “SPI Watchdog” was opened. This function group includes three properties which are each included in an entry with the tag <configitem>. In a similar manner to the function groups, these “configuration items” are also characterized by an ID and by a name.

The first “configuration item” of FIG. 4C is shown open in FIG. 4D. It includes a <regreference> tag and an <AppNotes> tag in addition to a <control> tag. In the example of FIG. 4D shown, the <regreference> entry defines a register having the name “WD-TO” and the address 0DH which activates the SPI watchdog when it 5 (i.e. the bit in the register having the third highest value) is set to “1”. The <appnotes> entry allows more precise indications on the associated <control> tag.

FIG. 4E shows the <control> tag of FIG. 4D open. The data structure in this example consists of a Boolean value which can adopt the values “True” and “False”, where “False” is represented by the register content “00000000” and “True” by the register content “00100000”. In addition to Boolean values, integers, strings and enumeration are also supported. More complex structures can be put together from the basic data types using enumerations.

In FIG. 4A, a chapter having the title “Application Notes” is shown which is shown open in FIG. 4F. Each entry under the tag <applicationnotes> in this chapter provides a function interface for the AUTOSAR run time environment. In FIG. 4F, a function is defined with the name “Demo”.

The described standardized data structure defines strictly and fixedly over the fixedly defined tags how the data have to be ordered in the structure. On the other hand, it is very flexible in that it allows great freedom in the allocation of names. The possibility for the description of the function of individual objects also substantially facilitates the understanding for the software developer and/or the project engineer who uses the standardized data structure.

As mentioned above, an integration of building blocks (e.g. standardized sensors, standardized actuators or discretely setup circuit portions which have a defined function) runs in a similar manner. As soon as descriptions or data sheets of these elements are present, a standardized data structure can be completed with the corresponding data and an integration of the building blocks into the standardized software architecture for embedded systems can be carried out.

1. A method for the integration of an integrated circuit into a standardized software architecture for embedded systems including the steps of:
defining a computer readable standardized data structure;
completing the standardized data structure with the properties of the integrated circuit;
using the completed standardized data structure for the definition of a hardware module which includes the integrated circuit; and
exporting the hardware module definition in a form which can be imported for further processing by the standardized software architecture for embedded systems.

2. A method in accordance with claim 1, characterized in that an extensible description language is used for the description of hierarchically structured data for the definition of the standardized data structure.

3. A method in accordance with claim 2, characterized in that the standardized data structure is completed with the properties of the integrated circuit by a manufacturer or distributor of the integrated circuit or by a developer of the hardware module.

4. A method in accordance with claim 3, characterized in that the definition of the hardware module includes
defining demands on the hardware module;
adding the completed standardized data structure and, optionally, further completed standardized data structures; and
configuring the hardware module being.

5. A method in accordance with claim 4, characterized in that the definition of the hardware module includes
configuring relationships between the integrated circuits covered by the hardware module;
configuring input/output interfaces and communication interfaces of the hardware module; and
preparing software modules for the integration of the hardware module into the standardized software architecture for embedded systems.

6. A computer readable memory medium with a computer program stored thereon which represents a set of instructions which, when they are executed by a computer, cause the computer to:
read in demands on a hardware module;
read in completed standardized data structures which describe the properties of integrated circuits covered by the hardware module;
read in relationships between the integrated circuits covered by the hardware module;
read in a configuration of input/output interfaces and communication interfaces of the hardware module;
support a preparation of software modules which are required for the integration of the hardware module into a standardizes software architecture for embedded systems; and
export the read in data and prepared software modules in a format readable by the standardized software architecture for embedded systems.

7. A computer readable memory medium in accordance with claim 6, wherein the hardware module includes an electronic control unit (ECU).

8. A computer readable memory medium in accordance with claim 6, wherein the standardized software architecture for embedded systems includes the open system architecture of the automotive industry (AUTOSAR Automotive Open System Architecture).
